(19) United States
(12) Patent Application Publication
(10) Pub. No.: US 2026/0267012 A1
(43) Pub. Date: Sep. 10, 2026

(54) METHOD FOR OPERATING AN OBJECT-DETECTING SENSOR

(71) Applicant: Robert Bosch GmbH, Stuttgart (DE)

(72) Inventor: Florian Mayer, Yokohama (JP)

(21) Appl. No.: 19/542,789

(22) Filed: Feb. 18, 2026

(30) Foreign Application Priority Data
Mar. 4, 2025 (DE) 10 2025 108 191.3

(51) Int. Cl. G01S 19/47; B60K 35/10

(52) U.S. Cl. CPC G01S 19/47; B60K 35/10

(57) ABSTRACT

A method for operating an object-detecting sensor of a vehicle. An item of speed information provided by a satellite navigation system of the vehicle is used as a reference speed for an object detection unit of the sensor.

### FIELD

The present disclosure relates to a method for operating an object-detecting sensor of a vehicle, to a corresponding object-detecting sensor, and to a corresponding computer program product.

### BACKGROUND INFORMATION

An object-detecting sensor can be, for example, a radar, a lidar, or a camera. In order to detect objects in a data stream of the sensor, an item of speed information about the movement speed of the sensor may be required. Within an acquisition region of the sensor static objects move relative to the sensor with this movement speed. Moving objects have a different relative speed in relation to the sensor.

In particular in feature-poor environments, such as on sand, snow or water, object detection without speed information can lead to false-positive and/or false-negative detected objects.

In the case of road vehicles, the speed information can usually be provided with sufficient accuracy via a wheel rotation speed.

### SUMMARY

The approach presented in the present disclosure provides a method for operating an object-detecting sensor of a vehicle, a corresponding object-detecting sensor, and a corresponding computer program product. Advantageous developments and improvements of the approach presented here emerge from the disclosure herein.

In the approach presented here, instead of (or in addition to) an item of speed information derived, for example, from an item of rotational speed information, an item of speed information provided by a satellite navigation system, i.e., output by it or derived from data output by it, is used as the reference speed in object detection.

Through the approach presented here, object detection and the safety functions based thereon can also be used in vehicles without defined contact with the ground, for example.

According to an example embodiment, a method for operating an object-detecting sensor of an off-road vehicle is proposed, wherein an item of speed information provided by a satellite navigation system of the vehicle is used as a reference speed for object detection by the sensor.

Ideas for embodiments of the present disclosure may be considered, inter alia, as being based on the concepts and findings described below.

An object-detecting sensor can be a radar sensor, a lidar sensor, or a camera sensor. The object-detecting sensor can therefore be active or passive. The sensor can comprise a measuring device for measuring or acquiring a physical quantity. In addition, the sensor can comprise a signal processing device for processing signals from the measuring device. The object-detecting sensor can generate an at least two-dimensional representation of an acquisition region. Objects in the acquisition region can be mapped in the representation. An algorithm for object detection running on the object-detecting sensor can search for and detect the objects mapped in the representation.

When the sensor moves relative to stationary objects, the objects in the representation appear to move at the same speed as the sensor, but in the opposite direction.

Using a reference speed, the algorithm can predict the apparent motion of the mapped objects and better distinguish moving objects from stationary objects.

The vehicle can be in particular an off-road vehicle, such as a snowmobile, hovercraft, boat, or jet ski. Unlike a road vehicle, it may therefore be the case that this vehicle does not have a defined contact with the ground. Due to the lack of defined contact, the speed of movement of the vehicle over the ground cannot be measured and reliably mapped with vehicle sensors, or at least not easily. Speed sensors that may be present on a propeller or drive chain are usually unable to provide reliable speed information due to unknown slippage at the propeller or drive chain.

The approach presented here uses an item of speed information calculated using satellite signals as the reference speed for object detection. The satellite signals can be generated or emitted by one or, preferably, a plurality of satellites. In a specific embodiment, they can also be referred to as GPS signals.

The reference speed can be supported using an item of at least uniaxial acceleration information provided by an inertial sensor system of the vehicle. In particular, the reference speed can be supported using an item of spatial acceleration information. An acquisition direction for the item of uniaxial acceleration information can particularly advantageously correspond to a main direction of movement of the vehicle. Through the item of acceleration information, a course of the speed can be acquired. The reference speed can thus also be co-coupled between times of acquisition of the satellite-based speed information. In particular, if the vehicle's speed changes between acquisition times, the reference speed can be determined with high accuracy. If the acceleration information is acquired spatially, movements of the vehicle transversely to the main direction of movement can also be acquired. As a result, drifts or jumps, for example, can be co-coupled.

The reference speed can be supported using an item of at least uniaxial rotation rate information provided by an inertial sensor system of the vehicle. In particular, the reference speed can be supported by using an item of spatial rotation rate information.

The item of uniaxial rotation rate information can be particularly advantageously acquired about a vertical axis of the vehicle. The rotation rate information can therefore represent in particular a yaw rate of the vehicle. The rotation rate information can be used to acquire changes in the direction of the vehicle. The reference speed can thus also be thus provided if the vehicle changes its direction of movement between the times at which the satellite-based speed information is acquired. If the rotation rate information can be used spatially, changes in direction about the longitudinal axis and/or transverse axis, i.e., roll movements and/or pitch movements, can also be acquired. As a result, for example up-and-down movements, such as drifts or jumps, can be co-coupled.

The speed information can be fused with the acceleration information and/or the rotation rate information to obtain the reference speed. The speed information, acceleration information, and rotation rate information can be treated equally. From each of these items of information, the movement of the vehicle can be derived with a high degree of quality. If one item of information is not very informative or is distorted, the other items of information can be used. For example, satellite-based speed information may have limited availability in forests or valleys. Then, using the acceleration and/or the rotation rate, co-coupling can be performed until the satellite-based speed information can be received as a reference point. Through simultaneous use of the items of information, false information can also be detected; for example, outliers can be easily detected since outliers occur in a statistically distributed manner and the probability of simultaneous outliers in multiple items of information is low.

The reference speed can be weighted during fusion by using a confidence value for the speed information provided by the satellite navigation system. The satellite navigation system can calculate a speed detection accuracy and represent it in the confidence value. If the confidence level is good, the satellite-based speed information can be used preferentially. If the confidence level is poor, the acceleration information and/or rotation rate information can be used with priority.

In the object detection unit, the speed of the vehicle can be derived from the relative movement of the objects. In particular when there are many detectable or visible objects, the speed can be determined with high accuracy. This speed can be compared with the speed information from the satellite navigation system. If the speed is detected by the object detection unit with high confidence, errors in satellite reception can be detected. Optical speed detection is good in particular in areas where the satellite navigation system has the greatest problems in determining position and consequently also in determining speed.

The method is preferably computer-implemented and can be implemented, for example, in software or hardware or in a mixed form of software and hardware, for example in an object-detecting sensor.

The approach presented here furthermore provides an object-detecting sensor, wherein the object-detecting sensor is designed to carry out, control or implement the steps of a variant of the method presented here.

The object-detecting sensor can be an electrical device comprising at least one computing unit for processing signals or data, at least one memory unit for storing signals or data, and at least one interface and/or a communication interface for reading in or outputting data embedded in a communication protocol. The computing unit can, for example, be a signal processor, a so-called system ASIC, or a microcontroller for processing sensor signals and outputting data signals depending on the sensor signals. The memory unit can, for example, be a flash memory, an EPROM, or a magnetic memory unit. The interface can be designed as a sensor interface for reading in the sensor signals from a sensor and/or as an actuator interface for outputting the data signals and/or control signals to an actuator. The communication interface can be designed to read in or output the data in a wireless and/or wired manner. The interfaces may also be software modules that are present, for example, on a microcontroller in addition to other software modules.

A computer program product or a computer program, which has program code that can be stored on a machine-readable carrier or storage medium, such as a semiconductor memory, a hard disk memory, or an optical memory, and that is used for carrying out, implementing, and/or controlling the steps of the method according to one of the example embodiments described above, in particular when the program product or program is executed on a computer or an apparatus, is advantageous as well.

It is pointed out that some of the possible features and advantages of the present disclosure are described herein with reference to different embodiments. A person skilled in the art will recognize that the features of the object-detecting sensor and of the method can be suitably combined, adapted or replaced in order to arrive at further embodiments of the present disclosure.

### BRIEF DESCRIPTION OF THE DRAWING

Example embodiments of the present disclosure are described below with reference to the figures, and neither the figures nor the description should be construed as limiting the present disclosure.

FIG. 1 shows a representation of a vehicle with an object-detecting sensor according to an exemplary embodiment.

The figure is merely schematic and not true to scale. Identical reference signs denote identical or identically acting features.

### DETAILED DESCRIPTION OF EXAMPLE EMBODIMENTS

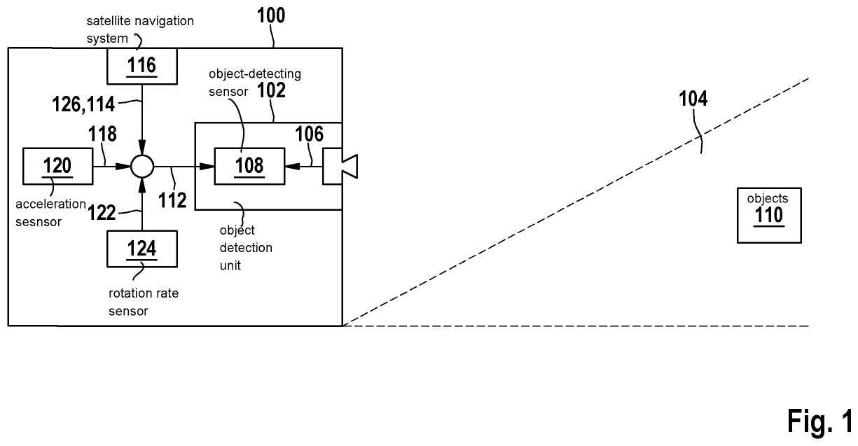

FIG. 1 shows a representation of a vehicle 100 with an object-detecting sensor 102 according to an exemplary embodiment. The vehicle 100 here is a non-road vehicle, such as a snowmobile, a buggy, a jet ski, or a boat. The sensor 102 acquires an acquisition region 104, in particular in front of the vehicle 100. The sensor 102 can be, for example, a radar sensor, a lidar sensor, or a camera. A radar sensor or lidar sensor illuminates the acquisition region 104 with radar waves or laser beams and receives echoes or reflections from the acquisition region 104. The camera acquires light from the acquisition region 104. All types of sensors map the light or the echoes in an item of image information 106 consisting of pixels. In the case of the camera, the image information 106 is two-dimensional. In the case of radar and lidar, the pixels additionally contain an item of distance information, and the image information 106 is three-dimensional.

The image information 106 is evaluated in an object detection unit 108 of the sensor 102 in order to detect objects 110 in the acquisition region 104.

When the vehicle 100 is moving, the image information 106 changes with the speed of the vehicle, since at least the static objects 110 move with the speed relative to the vehicle 100. The object detection unit 108 tracks the objects 110 in the image information 106. This tracking is improved when a reference speed 112 of the vehicle 100 is provided.

Since the non-road vehicle does not have a reliable or accurate speed sensor to acquire the speed, in the approach presented here an item of satellite-based speed information 114 is read in from a satellite navigation system 116 of the vehicle 100 and is used as the reference speed 112.

In one exemplary embodiment, the reference speed 112 is supported using an item of acceleration information 118 from an acceleration sensor 120 of the vehicle 100.

In one exemplary embodiment, the reference speed 112 is supported using an item of rotation rate information 122 from a rotation rate sensor 124 of the vehicle 100.

Here the acceleration information 118 and/or the rotation rate information 122 are at least uniaxial. The movement of the vehicle 100 can be co-coupled by using the acceleration information 118 and/or the rotation rate information 122.

In one exemplary embodiment, the satellite navigation system 116 provides a confidence value 126 which represents the accuracy of the speed information 114. The accuracy decreases, for example, when the satellite navigation system 116 has reduced satellite reception. For example, accuracy may decrease in a forest or a ravine. The confidence value 126 is read in and the reference speed 112 is more strongly based on the acceleration information 118 and/or the rotation rate information 122 if the accuracy of the speed information 114 decreases.

Possible embodiments of the present disclosure are summarized again below or described using slightly different words.

A method is presented for estimating vehicle speed based on GPS, acceleration and rotation rate of vehicles without wheel speed sensors, e.g. off-road vehicles with driver assistance systems.

U.S. Patent Application No. US 2016/0238714 describes a GPS system with dead reckoning navigation for tracked vehicles. The system uses wheel sensors and a gyroscope to measure the vehicle's movement and to calculate its position when no GPS signals are available. It integrates these measurements by means of an unscented Kalman filter in order to ensure accurate positioning.

U.S. Patent Application No. US 2010/0076681 relates to a dead reckoning navigation system that uses accelerometers to measure the longitudinal, lateral and vertical accelerations of a vehicle. These measurements are used to calculate the vehicle's position by integrating the accelerations and correcting for distortions and scaling factors.

These methods are essentially a technical implementation with signal values of the angular velocity. In addition, methods are described in which the use of accelerometers is discussed which are used to calculate specific references for validating GPS positions and speeds.

Driver assistance systems, e.g. based on radar, require vehicle speed information for triggering strategies and object detection. For off-road vehicles, such as PWCs (personal watercraft) or snowmobiles, classic speed information based on wheel rotational speed sensors is usually not available.

The core of the functions described here is a combination of GPS signals, acceleration and angular rate-based improvement in order to estimate the vehicle speed for driver assistance systems that require vehicle speed as input. This function is intended in particular for vehicles used off-highway have no wheel rotational speed sensors or the like.

The function described here is capable of estimating and evaluating various driving situations of a vehicle. The focus here is on distinguishing between situations relating to the vehicle's driving speed and, optionally to another situation, involving acceleration for various triggering strategies, such as radar-based functions. As a variant, GPS speed is used below as a basis to explain the combination of GPS speed and speed signal improvements through the use of additional sensor signals.

In GPS vehicle speed improvement, as input signal a GPS speed is used as the basis for providing the vehicle speed. The accuracy depends on the rate (e.g. one signal per second) and the availability of the satellites. An acceleration sensor signal in at least one axis is used as an additional input signal. In addition, the acceleration sensor signal in multiple axes of the vehicle coordinate system can be used. A rotation rate sensor signal in at least one axis is used as a further input signal. In addition, the rotation rate sensor signal in multiple axes of the vehicle coordinate system can be used.

The GPS-based speed signal is the basis for vehicle speed estimation, which varies in accuracy depending on sensor performance. This speed signal can be improved by so-called dead reckoning navigation, by adding acceleration signals to correlate changes in GPS speed with vehicle acceleration, thus improving the accuracy and robustness of the vehicle speed signal. To further improve the speed signal, rotation rate signals can also be added to this process. The signals can be filtered, e.g. with a low-pass filter, to improve the signal stability.

By using the acceleration sensor signals in a defined coordinate system, the vehicle speed can not only be determined in the direction of travel but can also be divided into lateral and longitudinal directions, which can provide additional information for radar-based systems. This can improve the triggering strategies for vehicles in drifts, e.g. for off-road sports vehicles, watercraft or snow vehicles.

Off-road vehicles are frequently used in wooded areas and valleys where GPS location and speed information coverage is poor. The technology presented here can improve the functionality of the speed-dependent radar-based system in these locales.

This improved vehicle speed is used in particular as an input signal for driver assistance systems for vehicles without wheel speed information. Speed is important for object detection, regardless of whether the assistance system is radar-based or camera-based.

The system can consist of a control unit, sensors (GPS module, acceleration sensor and/or gyroscope), a human-machine interface, and/or a control unit for active systems such as changes in engine torque.

Another advantage of this multi-source vehicle speed design, which is used for driver assistance systems, is a backup for estimating the vehicle speed as soon as one source is temporarily unavailable. For example if the GPS speed is temporarily unavailable.

Finally, it should be pointed out that terms like “having,” “comprising,” etc. do not exclude other elements or steps and terms like “a” or “an” do not exclude a plurality.

1-10. (canceled)

11. A method for operating an object-detecting sensor of a vehicle, the method comprising:
using an item of speed information provided by a satellite navigation system of the vehicle as a reference speed for an object detection unit of the sensor.

12. The method according to claim 11, wherein the reference speed is supported using an item of at least uniaxial acceleration information provided by an inertial sensor system of the vehicle.

13. The method according to claim 12, wherein the reference speed is supported using an item of spatial acceleration information.

14. The method according to claim 11, wherein the reference speed is supported using an item of at least uniaxial rotation rate information provided by an inertial sensor system of the vehicle.

15. The method according to claim 14, wherein the reference speed is supported using an item of spatial rotation rate information.

16. The method according to claim 12, wherein the speed information is fused with the acceleration information to form the reference speed.

17. The method according to claim 14, wherein the speed information is fused with the rotation rate information to form the reference speed.

18. The method according to claim 16, wherein the reference speed is weighted during the fusion by using a confidence value for the speed information provided by the satellite navigation system.

19. An object-detecting sensor of a vehicle, wherein the object-detecting sensor is configured to use an item of speed information provided by a satellite navigation system of the vehicle as a reference speed for an object detection unit of the sensor.

20. A non-transitory machine-readable storage medium on which is stored a computer program for operating an object-detecting sensor of a vehicle, the computer program, when executed by a processor, causing the processor to perform a method comprising:
using an item of speed information provided by a satellite navigation system of the vehicle as a reference speed for an object detection unit of the sensor.
